(19) United States
(12) Patent Application Publication
(10) Pub. No.: US 2021/0179948 A1
(43) Pub. Date: Jun. 17, 2021

(54) DEVICE AND METHOD FOR HEATING A FLUID IN A PIPELINE BY MEANS OF DIRECT CURRENT

(71) Applicant: BASF SE, Ludwigshafen am Rhein (DE)

(72) Inventors: Kiara Aenne KOCHENDOERFER, Ludwigshafen am Rhein (DE); Heinrich LAIB, Ludwigshafen am Rhein (DE); Andrey SHUSTOV, Ludwigshafen am Rhein (DE); Heinz-Juergen KUEHN, Ludwigshafen am Rhein (DE); Eric JENNE, Ludwigshafen am Rhein (DE); Reiner JACOB, Ludwigshafen am Rhein (DE)

(21) Appl. No.: 17/268,790

(22) PCT Filed: Aug. 15, 2019
(86) PCT No.: PCT/EP2019/071972

§ 371 Date: Feb. 16, 2021

(30) Foreign Application Priority Data
Aug. 16, 2018 (EP) 18189370.2

(51) Int. Cl. C10G 9/36; H05B 3/42; H05B 3/00; H05B 1/02; F16L 53/37; C10G 35/02; B01J 19/00

(52) U.S. Cl. CPC C10G 9/36; H05B 3/42; H05B 3/0009; H05B 1/0244; F16L 53/38; C10G 35/02; B01J 19/0013; H05B 2214/03; H05B 2203/012; F16L 53/37

(57) ABSTRACT

A device (110) for heating a fluid is proposed. The device comprises
at least one electrically conductive pipeline (112) and/or at least one electrically conductive pipeline segment (114) for receiving the fluid, and
at least one DC current and/or DC voltage source (126), wherein respectively one DC current or DC voltage source (126) is assigned to each pipeline (112) and/or each pipeline segment (114), said DC current and/or DC voltage source being connected to the respective pipeline (112) and/or the respective pipeline segment (114), wherein the respective DC current and/or DC voltage source (126) is embodied to produce an electric current in the respective pipeline (112) and/or in the respective pipeline segment (114), said electric current warming up the respective pipeline (112) and/or the respective pipeline segment (114) by Joule heating, which arises when the electric current passes through conductive pipe material, for the purposes of heating the fluid.

The invention relates to a device and a method for heating a fluid in a pipeline.

In principle, such devices are known. For example, WO 2015/197181 A1 describes a device for heating a fluid with at least one electrically conductive pipeline for receiving the fluid, and at least one voltage source connected to the at least one pipeline. The at least one voltage source is designed for generating in the at least one pipeline an electrical current, which warms up the at least one pipeline for heating the fluid. The at least one voltage source has M outer conductors, M being a natural number greater than or equal to two. The at least one voltage source is designed for providing an AC voltage on the outer conductors. Those AC voltages are phase-shifted with respect to one another by 2π/M. The outer conductors are connected to the at least one pipeline in an electrically conducting manner so as to form a star circuit.

In principle, apparatuses for heating a fluid in a pipeline are known. By way of example, FR 2 831 154 A1 describes electrical heating for assisting exothermic oxidation reactions and endothermic pyrolysis reactions at high temperatures in a continuous hydrocarbon reforming reactor. US 2014/238523 A1 describes an apparatus for heating a pipeline system comprising at least two pipelines, along which an electrical resistance heating element extends. US 2016/115025 A1 is a system and method for facilitating a chemical reaction. The system may comprise an electrical conductor, which is configured to hold a chemical mixture. The conductor is directly connected to an energy source and heated when the energy source is on. The chemical mixture is heated when the chemical mixture is in the conductor and the energy source is on, and a chemical reaction can occur. CN 201135883 Y describes a pipe reactor of the immediate heating type, which comprises a reaction pipe arranged in the center, a heat insulation layer that is covered outside of the reaction pipe and an electrical heating control device. The reaction pipe is directly connected to the electrical heating control device. The reaction pipe consists of a conductive material. The reaction pipe is used as a heating element. FR 2722359 A1 describes that a fluid passes through a uniform central bore of a line, the wall thickness of which increases in axially uniform fashion. An electrical energy source is connected between the ends. The resistance heating per unit length decreases with increasing thickness, with the required energy distribution being obtained by selecting suitable dimensions. US 2013/028580 A1 describes a line for transporting a hydrocarbon. The line comprises a hollow inner pipe that extends in the longitudinal direction in order to transport the fluid in the inner pipe and has an electrically insulating outer surface. A heating layer is arranged on the inner pipe, said heating layer comprising carbon fibers embedded in a polymer material. A heat insulation layer is arranged around the heating layer. An outer pipe is arranged around the heat insulation layer. The outer pipe is designed such that it can withstand an external pressure of at least 100 bar. Spacer means keep the outer pipe at a distance from the inner pipe in a fixed manner. Current supply means feed an electric current to the heating layer in order to warm up the inner pipe.

However, known devices for heating a fluid in a pipeline are often complicated from a technical point of view or can only be realized with much technical expense. The object of the present invention is therefore to provide a device and a method for heating a fluid that at least largely avoid the disadvantages of known apparatuses and methods. In particular, the device and method are intended to be technically simple to realize and easy to carry out and also economical. In particular, the device and the method should be applicable when heating fluids which cause a reduction in the insulation, for example a carbonization in cracking furnaces.

This object is achieved by a device having the features of claim 1 and by the method having the features of claim 12. Preferred refinements of the invention are specified inter alia in the associated dependent claims and dependency references of the dependent claims.

In the following, the terms “have”, “comprise” or “include” or any grammatical variations thereof are used in a non-exclusive way. Accordingly, these terms may relate both to situations in which there are no further features apart from the feature introduced by these terms or to situations in which there is or are one or more further features. For example, the expression “A has B”, “A comprises B” or “A includes B” may relate both to the situation in which, apart from B, there is no further element in A (i.e. to a situation in which A exclusively consists of B) and to the situation in which, in addition to B, there is or are one or more further elements in A, for example element C, elements C and D or even further elements.

It is also pointed out that the terms “at least one” and “one or more” and grammatical variations of these terms or similar terms, when they are used in connection with one or more elements or features and are intended to express that the element or feature may be provided one or more times, are generally only used once, for example when the feature or element is introduced for the first time. When the feature or element is subsequently mentioned again, the corresponding term “at least one” or “one or more” is generally no longer used, without restricting the possibility that the feature or element may be provided one or more times.

Furthermore, in the following the terms “preferably”, “in particular”, “for example” or similar terms are used in connection with optional features, without alternative embodiments being restricted thereby. Thus, features that are introduced by these terms are optional features, and it is not intended to restrict the scope of protection of the claims, and in particular of the independent claims, by these features. Thus, as a person skilled in the art will appreciate, the invention can also be carried out by using other configurations. In a similar way, features that are introduced by “in an embodiment of the invention” or by “in an example of the invention” are understood as optional features, without it being intended that alternative configurations or the scope of protection of the independent claims are restricted thereby. Furthermore, all of the possibilities of combining the features thereby introduced with other features, whether optional or non-optional features, are intended to remain unaffected by these introductory expressions.

In a first aspect of the present invention, a device for heating a fluid is proposed. Within the scope of the present invention, a “fluid” is understood as meaning a gaseous and/or liquid medium. The fluid may for example be selected from the group consisting of: water, steam, a combustion air, a hydrocarbon mixture, a hydrocarbon to be cracked. For example, the fluid may be a hydrocarbon to be thermally cracked, in particular a mixture of hydrocarbons to be thermally cracked. For example, the fluid may be water or steam and additionally comprise a hydrocarbon to be thermally cracked, in particular a mixture of hydrocarbons to be thermally cracked. The fluid may for example be a preheated mixture of hydrocarbons to be thermally cracked and steam. Other fluids are also conceivable. “Heating a fluid” may be understood as meaning a process that leads to a change in a temperature of the fluid, in particular to a rise in the temperature of the fluid, for example to a warming up of the fluid. For example, by the heating, the fluid may be warmed up to a prescribed or predetermined temperature value. For example, the fluid may be heated to a temperature in the range of 400° C. to 1200° C.

The device may be part of an installation. For example, the installation may be selected from the group consisting of: a steam cracker, a steam reformer, an apparatus for alkane dehydrogenation. For example, the installation may be designed for carrying out at least one process selected from the group consisting of: steam cracking, a steam reforming, alkane dehydrogenation.

The device may for example be part of a steam cracker. “Steam cracking” may be understood as meaning a process in which longer-chain hydrocarbons, for example naphtha, propane, butane and ethane, as well as gas oil and hydrowax, are converted into short-chain hydrocarbons by thermal cracking in the presence of steam. In steam cracking, hydrogen, methane, ethene and propene can be produced as the main product, as well as inter alia butenes and pyrolysis benzene. The steam cracker may be designed for warming up the fluid to a temperature in the range of 550° C. to 1100° C.

For example, the device may be part of a reformer furnace. “Steam reforming” may be understood as meaning a process for producing steam and carbon oxides from water and carbon-containing energy carriers, in particular hydrocarbons such as natural gas, light gasoline, methanol, biogas and biomass. For example, the fluid may be warmed up to a temperature in the range of 200° C. to 800° C., preferably of 400° C. to 700° C.

For example, the device may be part of an apparatus for alkane dehydrogenation. “Alkane dehydrogenation” may be understood as meaning a process for producing alkenes by dehydrogenating alkanes, for example dehydrogenating butane into butenes (BDH) or dehydrogenating propane into propene (PDH). The apparatus for alkane dehydrogenation may be designed for warming up the fluid to a temperature in the range of 400° C. to 700° C.

However, other temperatures and temperature ranges are also conceivable.

The device comprises:
at least one electrically conductive pipeline and/or at least one electrically conductive pipeline segment for receiving the fluid, and
at least one DC current and/or DC voltage source, wherein respectively one DC current or DC voltage source is assigned to each pipeline and/or each pipeline segment, said DC current and/or DC voltage source being connected to the respective pipeline and/or the respective pipeline segment, wherein the respective DC current and/or DC voltage source is embodied to produce an electric current in the respective pipeline and/or in the respective pipeline segment, said electric current heating the respective pipeline and/or the respective pipeline segment by Joule heating, which arises when the electric current passes through conductive pipe material, for the purposes of heating the fluid.

Within the scope of the present invention, a pipeline may be understood as meaning any shaped device designed for receiving and transporting the fluid. A pipeline segment may be understood as meaning a part of a pipeline. The pipeline may comprise at least one symmetric and/or at least one asymmetric pipe. The geometry and/or surfaces and/or material of the pipeline may be dependent on a fluid to be transported. An “electrically conductive pipeline” may be understood as meaning that the pipeline, in particular the material of the pipeline, is designed for conducting electrical current. The pipeline may be designed as a reaction pipe of a reformer furnace. The pipeline may be configured as a reaction pipe in at least one installation selected from the group consisting of: a steam cracker, a steam reformer, an apparatus for alkane dehydrogenation.

The device may comprise a plurality of pipelines and/or pipeline segments. The device may comprise L pipelines and/or pipeline segments, where L is a natural number greater than or equal to two. For example, the device may comprise at least two, three, four, five or more pipelines and/or pipeline segments. For example, the device may comprise up to one hundred pipelines and/or pipeline segments. The pipelines and/or pipeline segments may be configured identically or differently. The pipelines and/or pipeline segments may comprise symmetric and/or asymmetric pipes and/or combinations thereof. In the case of a purely symmetric configuration, the device may comprise pipelines and/or pipeline segments of an identical type of pipe. “Asymmetric pipes” and “combination of symmetric and asymmetric pipes” may be understood as meaning that the device may comprise any combination of types of pipe, which, moreover, may be connected as desired in parallel or in series, for example. A “type of pipe” may be understood as meaning a category or type of pipeline and/or pipeline segment that is characterized by certain features. The type of pipe may be characterized at least by one feature selected from the group consisting of: a horizontal configuration of the pipeline and/or pipeline segment; a vertical configuration of the pipeline and/or of the pipeline segment; a length in the entrance (L1) and/or in the exit (L2) and/or in the transition (L3); a diameter in the entrance (d1) and in the exit (d2) and/or transition (d3); a number n of passes; a length per pass; a diameter per pass; a geometry; the surface; and material. The device may comprise a combination of at least two different types of pipe, which are connected in parallel and/or in series. By way of example, the device may comprise pipelines and/or pipeline segments with different lengths in the entrance (L1) and/or exit (L2) and/or transition (L3). By way of example, the device may comprise pipelines and/or pipeline segments with an asymmetry of the diameters in the entrance (d1) and/or exit (d2) and/or transition (d3). By way of example, the device may comprise pipelines and/or pipeline segments with a different number of passes. By way of example, the device may comprise pipelines and/or pipeline segments with passes with different lengths per pass and/or different diameters per pass. In principle, any combination of any type of pipe in parallel and/or in series is conceivable. The device may comprise a plurality of feed inlets and/or feed outlets and/or production flows. A “feed” may be understood as meaning a substance flow that is supplied to the device. The pipelines and/or pipeline segments of different or identical type of pipe may be arranged in parallel and/or in series with a plurality of feed inlets and/or feed outlets. Pipelines and/or pipeline segments may be available as different types of pipe in the form of a kit and may be selected and combined as desired, depending on a use purpose. Using pipelines and/or pipeline segments of different types of pipe, it is possible to facilitate more accurate temperature control and/or an adaptation of the reaction in the case of varying feed and/or a selective yield of the reaction and/or an optimized process technology. The pipelines and/or pipeline segments may comprise identical or different geometries and/or surfaces and/or materials. The pipelines and/or pipeline segments may be through-connected, and thus form a pipe system for receiving the fluid. A “pipe system” may be understood as meaning an apparatus comprising at least two pipelines and/or pipeline segments, in particular connected to one another. The pipe system may comprise incoming and outgoing pipelines. The pipe system may comprise at least one inlet for receiving the fluid. The pipe system may comprise at least one outlet for discharging the fluid. “Through-connected” may be understood as meaning that the pipelines and/or pipeline segments are in fluid connection with one another. Thus, the pipelines and/or pipeline segments may be arranged and connected in such a way that the fluid flows through the pipelines and/or pipelines segments one after the other. The pipelines and/or pipeline segments may be connected parallel to one another in such a way that the fluid can flow through at least two pipelines and/or pipeline segments in parallel. The pipelines and/or pipeline segments, in particular the pipelines and/or pipeline segments connected in parallel, may be designed in such a way as to transport different fluids in parallel. In particular, the pipelines and/or pipeline segments connected in parallel may comprise geometries and/or surfaces and/or materials that are different from one another for transporting different fluids. In particular for the transport of a fluid, a number or all of the pipelines and/or pipeline segments may be configured as parallel, so that the fluid can be divided among those pipelines configured as parallel. Combinations of a series connection and a parallel connection are also conceivable.

The pipelines and/or pipeline segments and corresponding supply and removal pipelines may be connected to one another in fluid conducting fashion, when the pipelines and/or pipeline segments and the supply and removal pipelines may be galvanically isolated from one another. “Galvanically isolated” may be understood as meaning that the pipelines and/or pipeline segments and the supply and removal pipelines are separated from one another in such a way that there is no electrical conduction and/or a tolerable electrical conduction between the pipelines and/or pipeline segments and the supply and removal pipelines. The device may comprise at least one insulator, in particular a plurality of insulators. The galvanic isolation between the respective pipelines and/or pipeline segments and the supply and removal pipelines can be ensured by way of the insulators. The insulators can ensure a free through-flow of the fluid.

A “DC current source” may be understood as meaning an apparatus which is designed for providing a DC current. A “DC voltage source” may be understood as meaning an apparatus which is designed for providing a DC voltage. The DC current source and/or the DC voltage source are configured to produce a DC current in the respective pipeline and/or the respective pipeline segment. “DC current” may be understood as meaning an electric current that is substantially constant in terms of strength and direction. “DC voltage” may be understood as meaning a substantially constant electric voltage. “Substantially constant” may be understood as meaning a current or a voltage whose variations are unsubstantial for the intended effect.

Each of the pipelines and/or each pipeline segment may have assigned a DC current and/or DC voltage source, which is connected, in particular electrically by way of at least one electric connection, to the respective pipeline and/or the respective pipeline segment. For connecting the DC current and/or DC voltage sources and the respective pipeline and/or to the respective pipeline segment, the device may comprise 1 to N positive terminals and/or conductors and 1 to N negative terminals and/or conductors, where N is a natural number greater than or equal to two.

The device may comprise a plurality of DC current and/or DC voltage sources. Each pipeline and/or each pipeline segment may have assigned a DC current and/or DC voltage source, which is connected, in particular electrically by way of at least one electric connection, to the respective pipeline and/or the respective pipeline segment. For connecting the DC current and/or DC voltage sources and the respective pipeline and/or to the respective pipeline segment, the device may comprise 2 to N positive terminals and/or conductors and 2 to N negative terminals and/or conductors, where N is a natural number greater than or equal to three. The respective DC current and/or DC voltage source may be configured to produce an electric current in the respective pipeline and/or in the respective pipeline segment. The produced current can warm up the respective pipeline and/or the respective pipeline segment by Joule heating, which arises when the electric current passes through conductive pipe material, for the purposes of heating the fluid. “Warming up the pipeline and/or the pipeline segment” may be understood as meaning a process that leads to a change in a temperature of the pipeline and/or the pipeline segment, in particular a rise in the temperature of the pipeline and/or the pipeline segment.

Further, the device may comprise at least one heating wire, which may be wound around the pipeline and/or the pipeline segment, for example. The DC current and/or DC voltage source may be connected to the heating wire. The DC current and/or DC voltage source may be configured to produce a current in the heating wire and thus produce heat. The heating wire may be configured to warm up, in particular heat, the pipeline and/or the pipeline segment.

The DC current and/or DC voltage sources may be either controlled or uncontrolled. The DC current and/or DC voltage sources may be embodied with or without an option for closed-loop control of at least one electrical output variable. An “output variable” may be understood as meaning a current and/or a voltage value and/or a current and/or a voltage signal. The device may comprise 2 to M different DC current and/or DC voltage sources, where M is a natural number greater than or equal to three. The DC current and/or DC voltage sources may be electrically controllable independently of one another. Thus, for example, a different current may be produced in the respective pipelines and different temperatures can be reached in the pipelines.

Within the scope of the present invention, in a further aspect a method for heating a fluid is proposed. In the method, a device according to the invention is used. The method comprises the following steps:
providing at least one electrically conductive pipeline and/or at least one electrically conductive pipeline segment for receiving the fluid;
receiving the fluid in the pipeline and/or the pipeline segment;
providing at least one DC current and/or DC voltage source, wherein respectively one DC current or DC voltage source is assigned to each pipeline and/or each pipeline segment, said DC current or DC voltage source being connected to the respective pipeline and/or to the respective pipeline segment,
producing an electric current in the respective pipeline and/or the respective pipeline segment by the respective DC current and/or DC voltage source, said electric current warming up the respective pipeline and/or respective pipeline segment by Joule heating, which arises when the electric current passes through the conductive pipe material, for the purposes of heating the fluid.

With regard to embodiments and definitions, reference can be made to the above description of the unit. The method steps may be carried out in the sequence specified, it also being possible for one or more of the steps to be carried out at least partially simultaneously and it being possible for one or more of the steps to be repeated a number of times. In addition, further steps may be additionally performed, irrespective of whether or not they have been mentioned in the present application.

The fluid can flow through the respective pipelines and/or pipeline segments of the device and may be heated in the latter by virtue of the pipelines being heated by a DC current applied to these pipelines and/or pipeline segments from the DC current and/or DC voltage sources such that Joule heating is produced in the pipelines and/or pipeline segments, which is transferred to the fluid such that the latter is heated when flowing through the pipelines and/or pipeline segments.

For example, a hydrocarbon to be thermally cracked, in particular a mixture of hydrocarbons to be thermally cracked, may be heated as fluid.

By way of example, water or steam may be heated as fluid, with said water or said steam being heated to a temperature in the range of 550° C. to 700° C., in particular, and the fluid additionally including, in particular comprising, hydrocarbon to be thermally cracked, in particular a mixture of hydrocarbons to be thermally cracked. The fluid to be heated may be a preheated mixture of hydrocarbons to be thermally cracked and steam.

By way of example, combustion air of a reformer furnace may be preheated or heated as fluid, for example to a temperature in the range of 200° C. to 800° C., preferably 400° C. to 700° C.

By way of example, the pipeline may be embodied as a reaction pipe of a reformer furnace.

To sum up, the following embodiments are particularly preferred within the scope of the present invention:

### Embodiment 1

A device for heating a fluid, comprising
at least one electrically conductive pipeline and/or at least one electrically conductive pipeline segment for receiving the fluid, and
at least one DC current and/or DC voltage source, wherein respectively one DC current or DC voltage source is assigned to each pipeline and/or each pipeline segment, said DC current and/or DC voltage source being connected to the respective pipeline and/or the respective pipeline segment, wherein the respective DC current and/or DC voltage source is embodied to produce an electric current in the respective pipeline and/or in the respective pipeline segment, said electric current heating the respective pipeline and/or the respective pipeline segment by Joule heating, which arises when the electric current passes through conductive pipe material, for the purposes of heating the fluid.

### Embodiment 2

The device according to the preceding embodiment, wherein the device comprises a plurality of pipelines and/or pipeline segments, wherein the pipelines and/or pipeline segments are through-connected and consequently form a pipe system for receiving a fluid.

### Embodiment 3

The device according any one of the preceding embodiments, wherein the device comprises L pipelines and/or pipeline segments, where L is a natural number greater than or equal to two, wherein the pipelines and/or pipeline segments comprise symmetric and/or asymmetric pipes and/or a combination thereof.

### Embodiment 4

The device according to any one of the preceding embodiments, wherein the device comprises L pipelines and/or pipeline segments, where L is a natural number greater than or equal to two, wherein the device comprises a combination of at least two different type of pipe, which are connected in parallel and/or in series, wherein the type of pipe is characterized at least by one feature selected of the group consisting of: a horizontal configuration of the pipeline and/or pipeline segment; a vertical configuration of the pipeline and/or of the pipeline segment; a length in the entrance (L1) and/or in the exit (L2) and/or in the transition (L3); a diameter in the entrance (d1) and in the exit (d2) and/or transition (d3); a number n of passes; a length per pass; a diameter per pass; a geometry; the surface; and material.

### Embodiment 5

The device according to any one of the three preceding embodiments, wherein the pipelines and/or pipeline segments and appropriate supply and removal pipelines are connected to one another in fluid conducting fashion, wherein the pipelines and/or pipeline segments and the supply and removal pipelines are galvanically isolated from one another.

### Embodiment 6

The device according to the preceding embodiment, wherein the device comprises insulators that are configured for galvanic isolation between the respective pipelines and/or pipeline segments and the supply and removal pipelines, wherein the insulators are configured to ensure a free through-flow of the fluid.

### Embodiment 7

The device according to any one of the five preceding embodiments, wherein a plurality or all of the pipelines and/or pipeline segments are configured in series and/or in parallel.

### Embodiment 8

The device according to any one of the preceding embodiments, wherein the device comprises a plurality of DC current and/or DC voltage sources, wherein the DC current and/or DC voltage sources are embodied with/without an option for closed-loop control of at least one electrical output variable.

### Embodiment 9

The device according to the preceding embodiment, wherein the device for connecting the DC current and/or DC voltage sources and the respective pipeline and/or to the respective pipeline segment comprises 2 to N positive terminals and/or conductors and 2 to N negative terminals and/or conductors, where N is a natural number greater than or equal to three.

### Embodiment 10

The device according to either of the two preceding embodiments, wherein the respective DC current and/or DC voltage sources are configured identically or differently.

### Embodiment 11

The device according to the preceding embodiment, wherein the device comprises 2 to M different DC current and/or DC voltage sources, where M is a natural number greater than or equal to three, wherein the DC current and/or DC voltage sources are electrically controllable independently of one another.

### Embodiment 12

An installation comprising at least one device according to any one of the preceding embodiments.

### Embodiment 123

The installation according to the preceding embodiment, wherein the installation is selected from the group consisting of: a steam cracker, a steam reformer, an apparatus for alkane dehydrogenation.

### Embodiment 14

A method for heating a fluid by using a device according to any one of the preceding embodiments relating to a device, the method comprising the following steps:
providing at least one electrically conductive pipeline and/or at least one electrically conductive pipeline segment for receiving the fluid;
receiving the fluid in the pipeline and/or the pipeline segment;
providing at least one DC current and/or DC voltage source, wherein respectively one DC current or DC voltage source is assigned to each pipeline and/or each pipeline segment, said DC current or DC voltage source being connected to the respective pipeline and/or to the respective pipeline segment,
producing an electric current in the respective pipeline and/or the respective pipeline segment by the respective DC current and/or DC voltage source, said electric current warming up the respective pipeline and/or respective pipeline segment by Joule heating, which arises when the electric current passes through the conductive pipe material, for the purposes of heating the fluid.

### Embodiment 15

The method according to the preceding embodiment, wherein a hydrocarbon to be thermally cracked, in particular a mixture of hydrocarbons to be thermally cracked, is heated as a fluid.

### Embodiment 16

The method according to any one of the preceding embodiments relating to a method, wherein water or steam is heated as a fluid, wherein said water or said steam is more particularly heated to a temperature in the range of 550° C. to 700° C., and the fluid additionally comprises a hydrocarbon to be thermally cracked, in particular a mixture of hydrocarbons to be thermally cracked, wherein the fluid to be heated is a preheated mixture of hydrocarbons to be thermally cracked and steam.

### Embodiment 17

The method according to any one of the preceding embodiments relating to a method, wherein combustion air of a reformer furnace is preheated as a fluid, for example to a temperature in the range of 200° C. to 800° C., preferably 400° C. to 700° C.

### Embodiment 18

The method according to any one of the preceding embodiments relating to a method, wherein the pipelines are embodied as reaction pipes for a reformer furnace.

### BRIEF DESCRIPTION OF THE FIGURES

Further details and features of the invention may be found in the following description of preferred examples, in particular in conjunction with the dependent claims. The respective features may be implemented separately, or several of them may be implemented in combination with one another. The invention is not restricted to the examples. The examples are diagrammatically represented in the figures. References which are the same in the individual figures denote elements which are the same or have the same function, i.e. they correspond to one another in respect of their functions.

Specifically:

FIGS. 1a to 1c show diagrammatic illustrations of examples of a device according to the invention;

FIG. 2 shows a diagrammatic illustration of a further example of the device according to the invention;

FIG. 3 shows a diagrammatic illustration of a further example of the device according to the invention;

FIGS. 4a and b show diagrammatic illustrations of further examples of the device according to the invention;

FIGS. 5a to 5c show diagrammatic illustrations of examples of a device according to the invention;

FIG. 6 shows a diagrammatic illustration of a further example of the device according to the invention;

FIG. 7 shows a diagrammatic illustration of a further example of the device according to the invention;

FIGS. 8a and 8b show diagrammatic illustrations of further examples of the device according to the invention;

FIGS. 9Ai to Cvi show diagrammatic illustrations of types of pipe; and

FIGS. 10 a to y show a kit with types of pipe and examples according to the invention of combinations of pipelines and/or pipeline segments.

### EXAMPLES

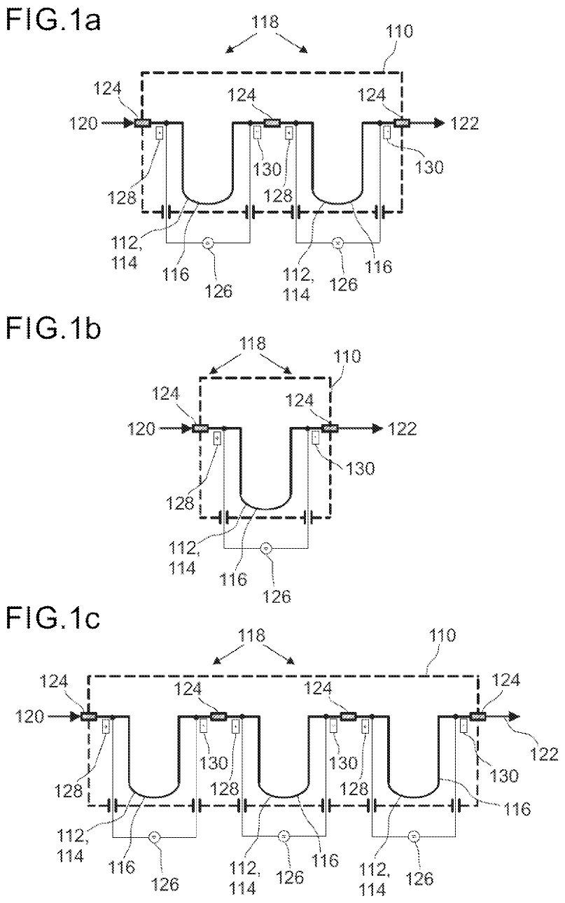

FIGS. 1a to 1c each show a diagrammatic illustration of an example of a device 110 according to the invention for heating a fluid. The device 110 comprises at least one electrically conductive pipeline 112 and/or at least one electrically conductive pipeline segment 114 for receiving the fluid. The fluid may be a gaseous and/or liquid medium. The fluid may for example be selected from the group consisting of: water, steam, a combustion air, a hydrocarbon mixture, a hydrocarbon to be cracked. For example, the fluid may be a hydrocarbon to be thermally cracked, in particular a mixture of hydrocarbons to be thermally cracked. For example, the fluid may be water or steam and additionally comprise a hydrocarbon to be thermally cracked, in particular a mixture of hydrocarbons to be thermally cracked. The fluid may for example be a preheated mixture of hydrocarbons to be thermally cracked and steam. Other fluids are also conceivable. The device 110 may be configured to warm up the fluid, in particular bring about an increase in the temperature of the fluid. For example, by the heating, the fluid may be heated to a prescribed or predetermined temperature value. For example, the fluid may be heated to a temperature in the range of 400° C. to 1200° C.

For example, the device 110 may be part of an installation. For example, the installation may be selected from the group consisting of: a steam cracker, a steam reformer, an apparatus for alkane dehydrogenation. For example, the device 110 may be designed for carrying out at least one process selected from the group consisting of: steam cracking, steam reforming, alkane dehydrogenation. The device 110 may for example be part of a steam cracker. The steam cracker may be designed for warming up the fluid to a temperature in the range of 550° C. to 1100° C. For example, the device 110 may be part of a reformer furnace. For example, the fluid may be a combustion air of a reformer furnace which is prewarmed or heated up, for example to a temperature in the range of 200° C. to 800° C., preferably of 400° C. to 700° C. For example, the device 110 may be part of an apparatus for alkane dehydrogenation. The apparatus for alkane dehydrogenation may be designed for warming up the fluid to a temperature in the range of 400° C. to 700° C. However, other temperatures and temperature ranges are also conceivable.

The pipeline 112 and/or the pipeline segment 114 may be configured to receive and transport the fluid. The pipeline 112 and/or the pipeline segment 114 may comprise at least one limb 116 or a winding. The pipeline 112 may comprise at least one symmetric and/or at least one asymmetric pipe. FIG. 1c shows an embodiment with three symmetric pipelines 112 and/or pipeline segments 114 The geometry and/or surfaces and/or material of the pipeline 112 may be dependent on a fluid to be transported. The pipeline 112 and/or the pipeline segment 114 may be configured to conduct electric current. The pipeline 112 may be designed as a reaction pipe of a reformer furnace.

FIG. 1b shows an example in which the device comprises a pipeline 112. The device 110 may comprise a plurality of pipelines 112 and/or pipeline segments 114, for example two, as shown in FIG. 1a, or three, as shown in FIG. 1c. The device 110 may comprise L pipelines 112 and/or pipeline segments 114, where Lisa natural number greater than or equal to two. For example, the device 110 may comprise at least two, three, four, five or more pipelines 112 and/or pipeline segments 114. For example, the device 110 may comprise up to one hundred pipelines 112 and/or pipeline segments 114. The pipelines 112 and/or pipeline segments 114 may be configured identically or differently. The pipelines 112 and/or pipeline segments 114 may be through-connected, and thus form a pipe system 118 for receiving the fluid. The pipe system 118 may comprise incoming and outgoing pipelines 112. The pipe system 118 may comprise at least one inlet 120 for receiving the fluid. The pipe system 118 may comprise at least one outlet 122 for discharging the fluid. FIG. 1 shows an embodiment in which the pipelines 112 and/or pipeline segments 114 are arranged and connected in such a way that the fluid flows through the pipelines 112 and/or pipelines segments 114 one after the other.

The pipelines 112 and/or pipeline segments 114 and corresponding supply and removal pipelines may be connected to one another in fluid conducting fashion, wherein the pipelines 112 and/or pipeline segments 114 and the supply and removal pipelines may be galvanically isolated from one another. The device 110 may comprise at least one galvanic isolation, in particular at least one insulator 124, more particularly a plurality of insulators 124. The galvanic isolation between the respective pipelines 112 and/or pipeline segments 114 and the supply and removal pipelines can be ensured by way of the insulators 124. The insulators 124 can ensure a free through-flow of the fluid.

The device 110 comprises at least one DC current and/or DC voltage source 126. The device 110 may comprise a plurality of DC current and/or DC voltage sources 126, for example three, as shown in FIG. 1c in exemplary fashion. The device 110 may comprise 2 to M different DC current and/or DC voltage sources 126, where M is a natural number greater than or equal to three. The DC current and/or DC voltage source 126 is connected to the respective pipeline 112 and/or to the respective pipeline segment 114, in particular electrically by way of at least one electrical connection. For connecting the DC current and/or DC voltage sources 126 and the respective pipeline 112 and/or to the respective pipeline segment 114, the device 110 may comprise 2 to N positive terminals and/or conductors 128 and 2 to N negative terminals and/or conductors 130, where N is a natural number greater than or equal to three. The DC current and/or DC voltage sources 126 may be either controlled or uncontrolled. The DC current and/or DC voltage sources 126 may be embodied with or without an option for closed-loop control of at least one electrical output variable. The DC current and/or DC voltage sources 126 may be electrically controllable independently of one another. Thus, for example, a different current may be produced in the respective pipelines 112 and different temperatures may be reached in the pipelines 112.

The respective DC current and/or the DC voltage source 126 may be configured to produce an electric current in the respective pipeline 112 and/or in the respective pipeline segment 114. The produced current can warm up the respective pipeline 112 and/or the respective pipeline segment 114 by Joule heating, which arises when the electric current passes through conductive pipe material, for the purposes of heating the fluid.

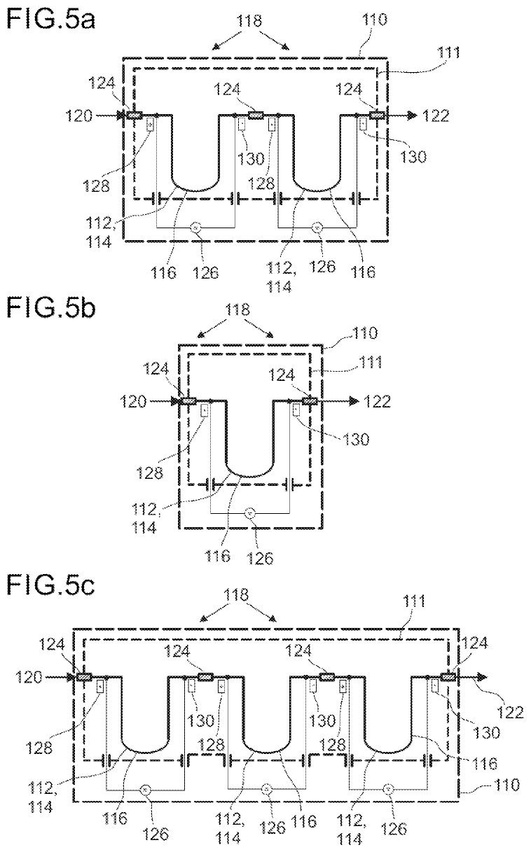

FIGS. 5a to 5c each show a diagrammatic illustration of an example of a device 110 according to the invention for heating a fluid, wherein a reaction space 111 of the device 110 is furthermore illustrated in each of the examples of FIGS. 5a to 5c. In respect of the further elements of FIG. 5a, reference can be made to the description of FIG. 1a. In respect of the further elements of FIG. 5b, reference can be made to the description of FIG. 1b. In respect of the further elements of FIG. 5c, reference can be made to the description of FIG. 1c.

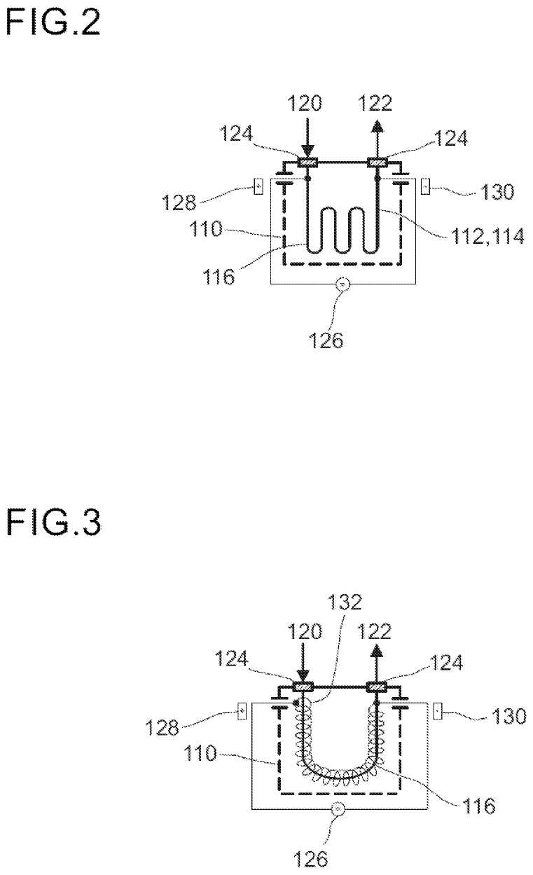

FIG. 2 shows a further embodiment of the device 110 according to the invention. In respect of the configuration of the device, reference is made to the description relating to FIG. 1, with the following peculiarities. In this embodiment, the device 110 comprises a pipeline 112 and/or pipeline segments 114 with three limbs 116 or windings, which are fluid-connected. The device comprises the inlet 120 and the outlet 122. The fluid can flow through the pipeline 112 and/or the pipeline segments 114 in series, from the inlet 120 to the outlet 122. The device 110 may comprise the insulators 124, for example two insulators 124 as shown in FIG. 2, for the purposes of the galvanic isolation. In this embodiment, the device 110 comprises one DC current and/or DC voltage source 126. For connecting the DC current and/or DC voltage source 126 and the pipeline 112 and/or to the respective pipeline segment 114, the device 110 may comprise a positive terminal and/or conductor 128 and a negative terminal and/or conductor 130.

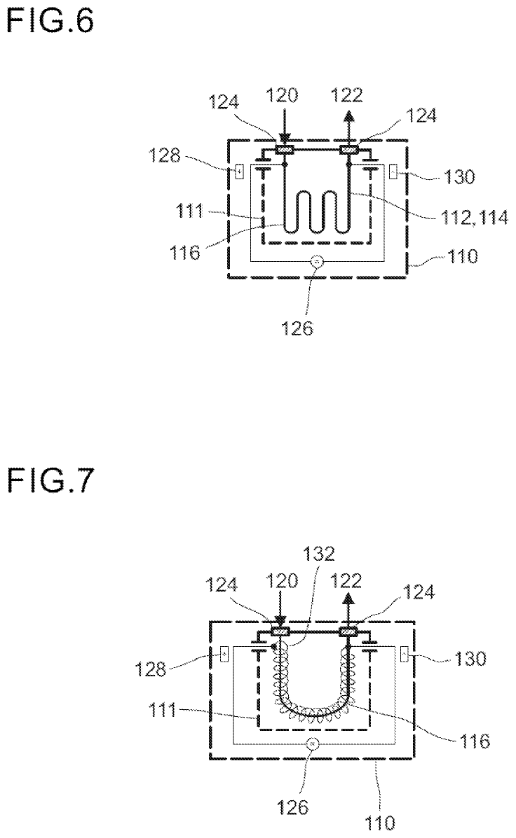

FIG. 6 shows a diagrammatic illustration of an example of a device 110 according to the invention for heating a fluid, wherein respectively one reaction space 111 of the device 110 is furthermore illustrated in the example of FIG. 6. In respect of the further elements of FIG. 6, reference can be made to the description of FIG. 2.

FIG. 3 shows a further embodiment of the device 110 according to the invention. In respect of the configuration of the device, reference is made to the description relating to FIG. 1, with the following peculiarities. In the embodiment of FIG. 3 In this embodiment, the device 110 comprises a pipeline 112 and/or pipeline segments 114 with a limb 116 or a winding. The device 110 may comprise the insulators 124, for example two insulators 124 as shown in FIG. 3, for the purposes of the galvanic isolation. In this embodiment, the device 110 comprises one DC current and/or DC voltage source 126. Further, the device 110 may comprise at least one heating wire 132, which may be wound around the pipeline and/or the pipeline segment, for example. The DC current and/or DC voltage source 126 may be connected to the heating wire 132. The DC current and/or DC voltage source 126 may be configured to produce a current in the heating wire 132 and thus produce heat. The heating wire 132 may be configured to warm up the pipeline 112 and/or the pipeline segment 114.

FIG. 7 shows a diagrammatic illustration of an example of a device 110 according to the invention for heating a fluid, wherein respectively one reaction space 111 of the device 110 is furthermore illustrated in the example of FIG. 7. In respect of the further elements of FIG. 7, reference can be made to the description of FIG. 3.

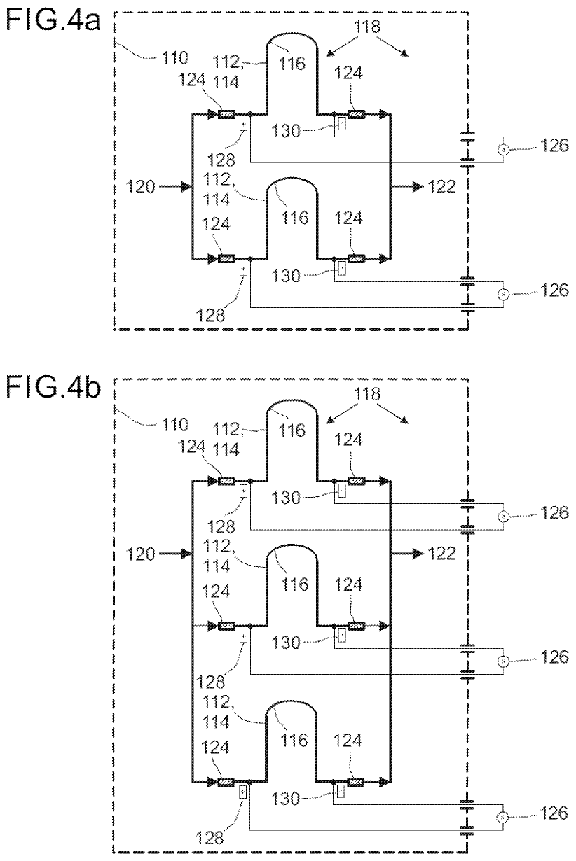

The pipelines 112 are arranged in series in the examples of FIGS. 1a and 1c. FIGS. 4a and 4b show embodiments with pipelines 112 and/or pipeline segments 114 connected in parallel, with two pipelines 112 and/or pipeline segments 114 in FIG. 4a and with 3 parallel pipelines 112 and/or pipeline segments 114 in FIG. 4b. Other numbers of parallel pipelines 112 and/or pipeline segments 114 are also conceivable. In FIGS. 4a and 4b, the device 110 comprises an inlet 120 and an outlet 122. The pipelines 112 and/or pipeline segments 114 may be connected with respect to one another in such a way that the fluid can flow through at least two pipelines 112 and/or pipeline segments 114 in parallel. The pipelines 112 and/or pipeline segments 114 connected in parallel may comprise geometries and/or surfaces and/or materials that differ from one another. By way of example, the pipelines 112 and/or pipeline segments 114 connected in parallel may have different numbers of limbs 116 or windings.

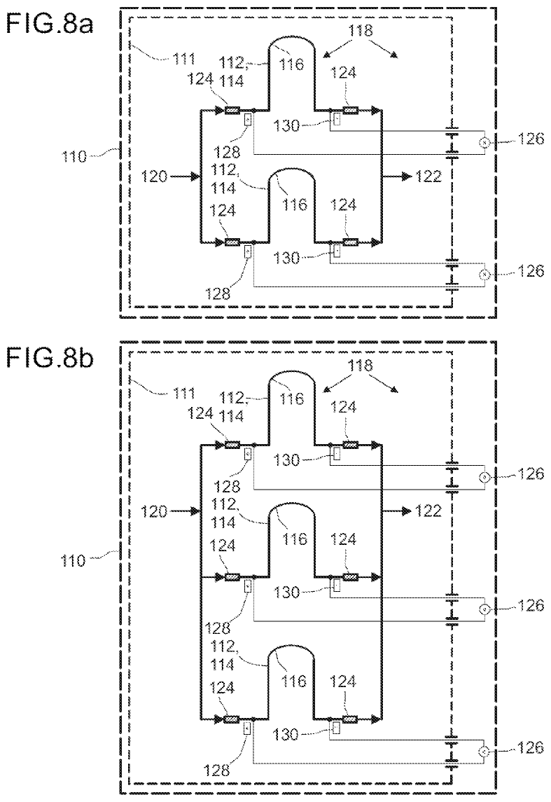

FIGS. 8a and 8b each show a diagrammatic illustration of an example of a device 110 according to the invention for heating a fluid, wherein a reaction space 111 of the device 110 is furthermore illustrated in each of the examples of FIGS. 8a and 8b. In respect of the further elements of FIG. 8a, reference can be made to the description of FIG. 4a. In respect of the further elements of FIG. 8b, reference can be made to the description of FIG. 4b.

The device 110 may comprise symmetric and/asymmetric pipes and/or combinations thereof. In the case of a purely symmetric configuration, the device 110 may comprise pipelines 112 and/or pipeline segments 114 of an identical type of pipe. The device 110 may comprise any combination of types of pipe which, for example, may moreover be connected in parallel or in series as desired. The type of pipe may be characterized at least by one feature selected from the group consisting of: a horizontal configuration of the pipeline 112 and/or pipeline segment 114; a vertical configuration of the pipeline 112 and/or of the pipeline segment 114; a length in the entrance (L1) and/or in the exit (L2) and/or in the transition (L3); a diameter in the entrance (d1) and in the exit (d2) and/or transition (d3); a number n of passes; a length per pass; a diameter per pass; a geometry; the surface; and material. Alternatively or in addition, the type of pipe may be selected from at least one pipeline 112 and/or at least one pipeline segment 114 with or without galvanic isolation and/or ground connection 125. The galvanic isolation may for example be configured using an insulator 124. For example, a galvanic isolation may be provided at the inlet 120 of the pipeline 112 and/or of the pipe segment 114 and a galvanic isolation may be provided at the outlet 122 of the pipeline 112 and/or of the pipeline segment 114. For example, a galvanic isolation may be provided at the inlet 120 of the pipeline 112 and/or of the pipe segment 114 and a ground connection 125 may be provided at the outlet 122 of the pipeline 112 and/or of the pipe segment 114. For example, a galvanic isolation may be provided only at the inlet 120 of the pipeline 112 and/or of the pipe segment 114. For example, a ground connection 125 may be provided only at the inlet 120 of the pipeline 112 and/or of the pipe segment 114. For example, the pipeline 112 and/or the pipe segment 114 may be provided without a ground connection 125 at the inlet 120 and outlet 122 and/or without galvanic isolation at the inlet 120 and outlet 122. Alternatively or in addition, the type of pipe may be characterized by a flow direction of the fluid. The fluid may basically flow in two flow directions, referred to as first and second flow direction. The first and the second flow direction may be opposite. Alternatively or in addition, the type of pipe may be characterized by an application of direct current to the pipeline 112 and/or to the pipe segment 114. For example, an infeed of direct current may be performed at an arbitrary location of the pipeline 112 and/or of the pipe segment 114 between at least two negative terminals and/or conductors. For example, the infeed may be performed in the middle between two negative terminals, such that a resistance of the pipeline 112 and/or of the pipe segment 114 is divided into two partial resistances R1 and R2. Half of the direct current can flow to a first negative terminal, and a second half can flow to a second negative terminal. The infeed may also be performed at an arbitrary location between the negative terminals/conductors, such that different partial resistances are realized. For example, an infeed of the direct current may be performed via a negative terminal and/or conductor and a positive terminal and/or conductor on the pipeline 112 and/or the pipe segment 114. For example, the direct current can flow from the positive to the negative terminal, and the pipeline 112 and/or the pipe segment 114 can be considered as an overall resistance R. Any desired combination of the types of pipe is possible here.

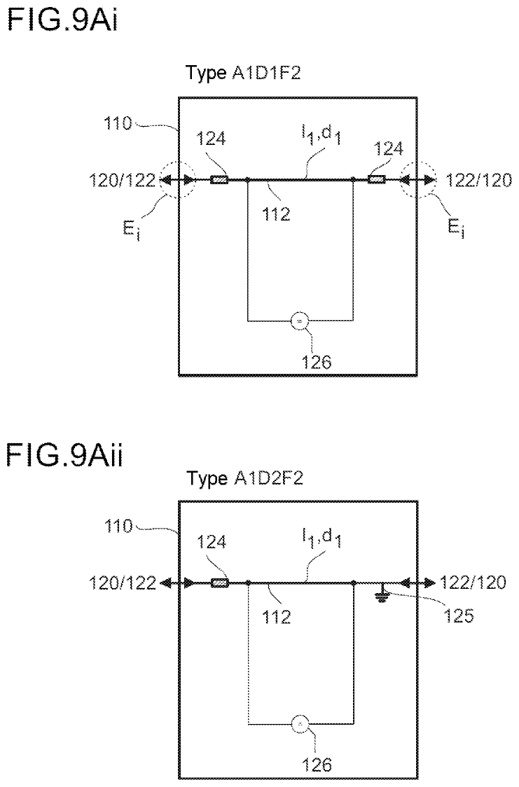

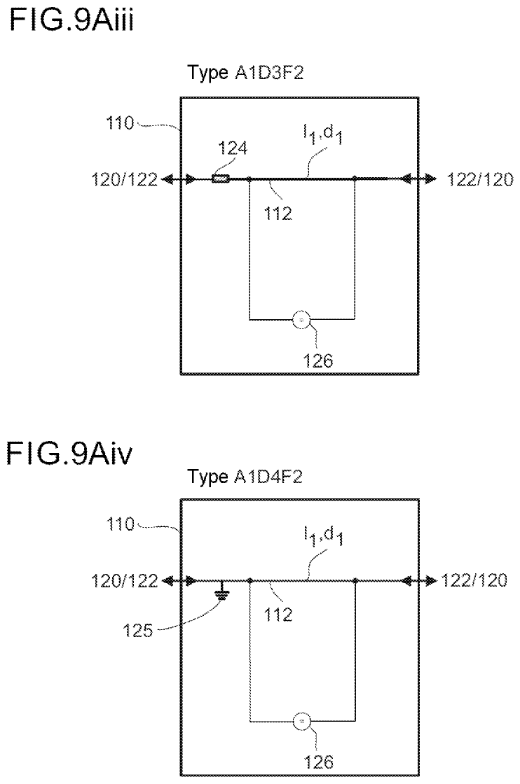

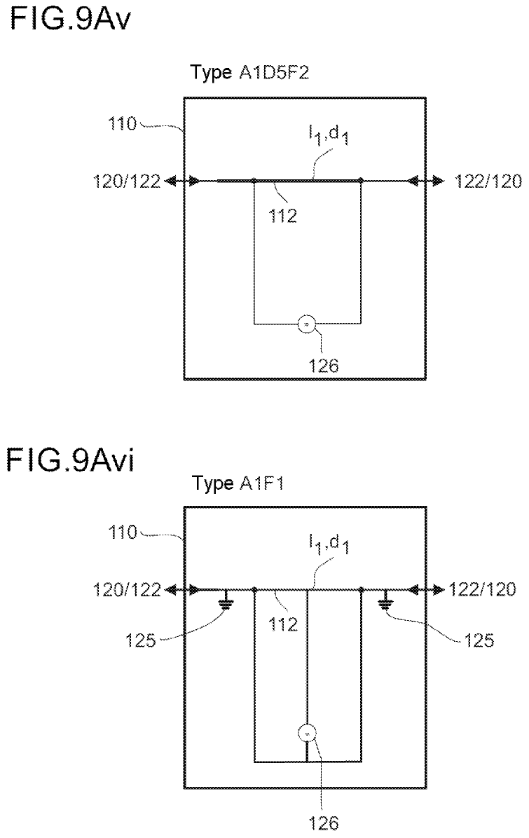

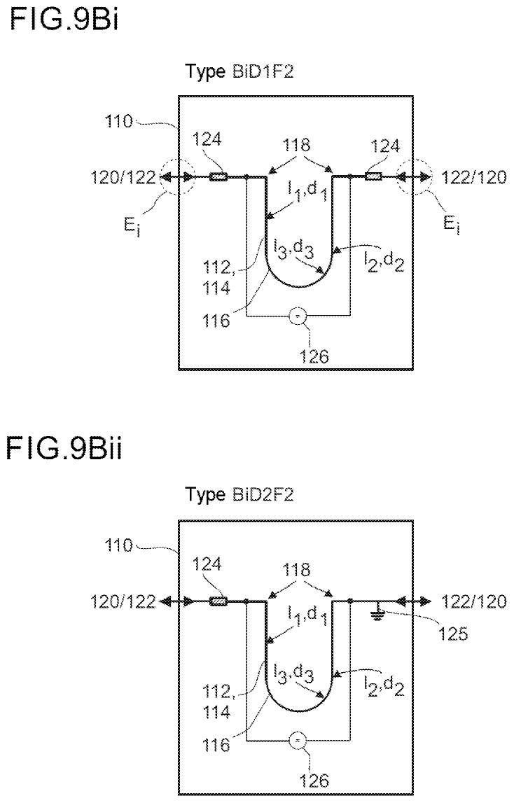

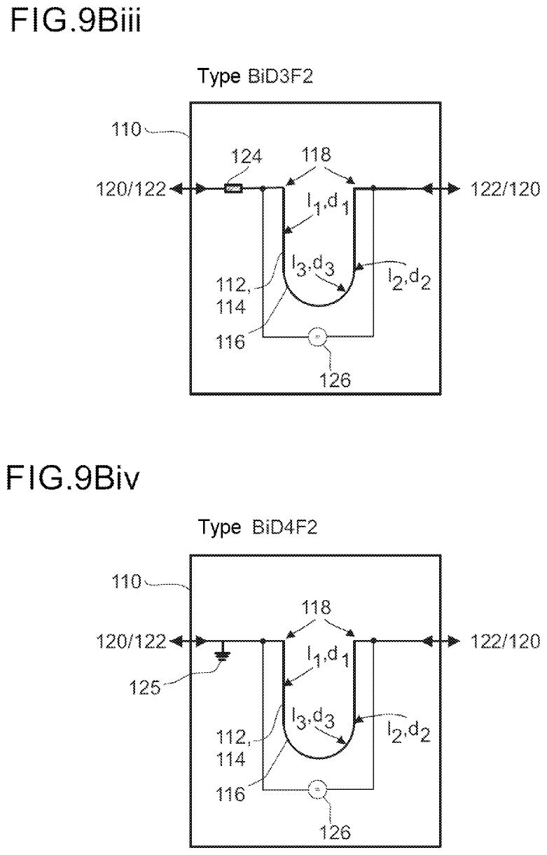

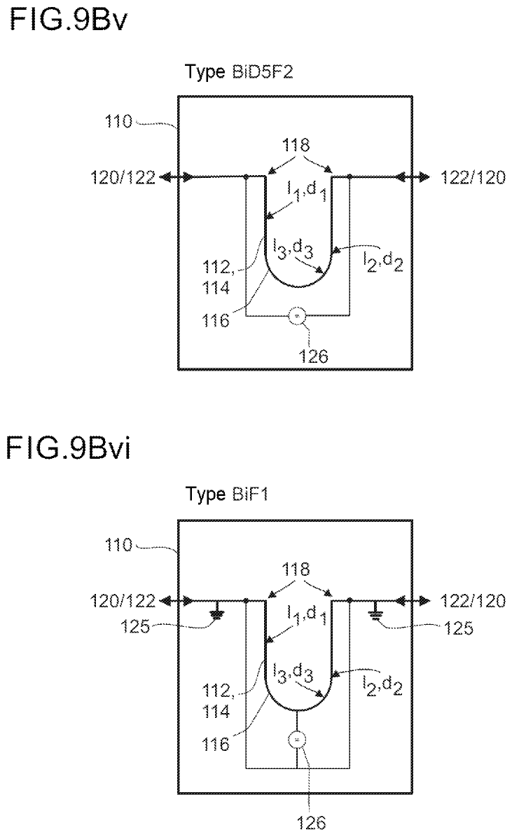

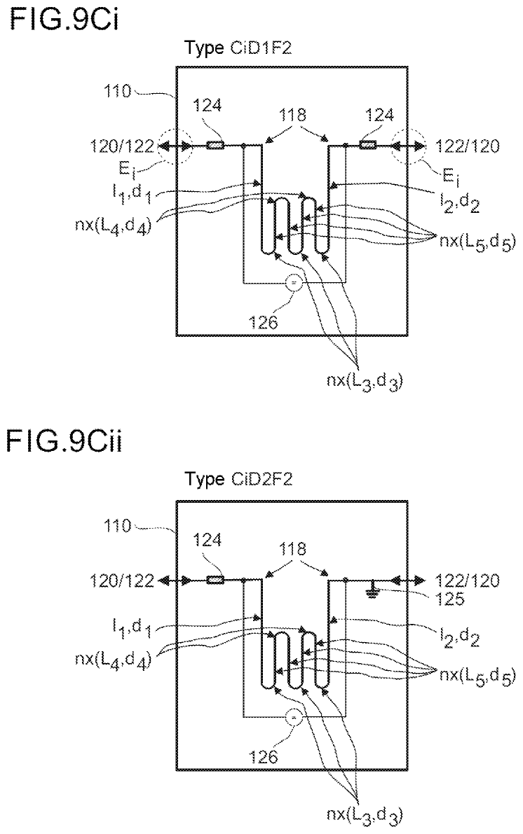

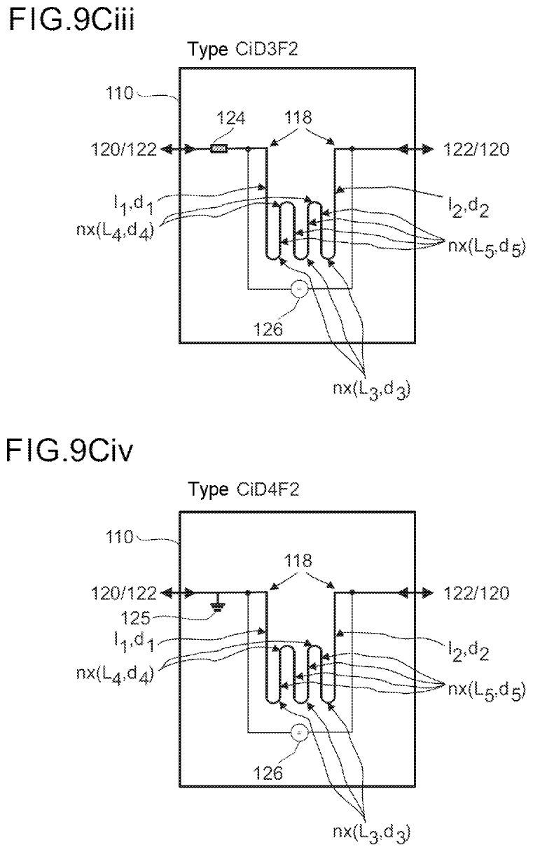

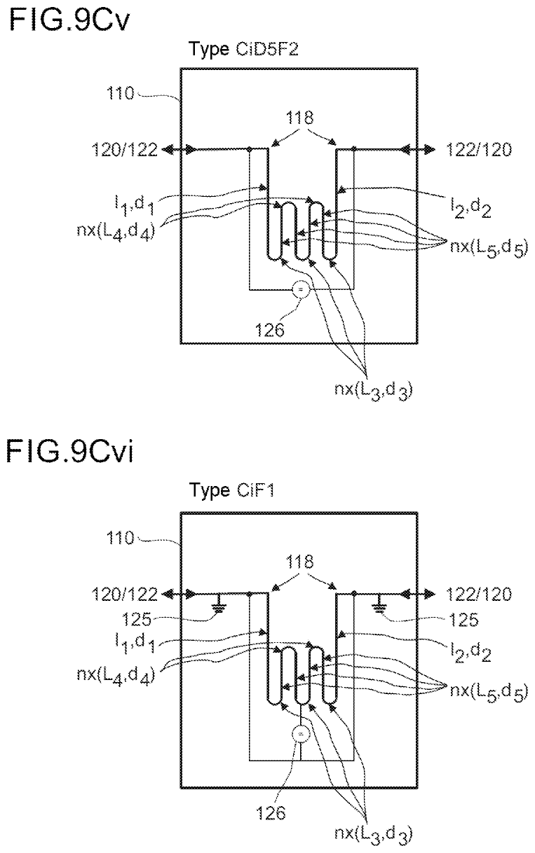

FIGS. 9Ai to Civ show exemplary possible embodiments of types of pipe in diagrammatic illustration. Here, in FIGS. 9A1 to Civ, the type of pipe is indicated in each case. This may be divided into the following categories, wherein all conceivable combinations of the categories are possible:
Category A specifies an extent of the pipeline 112 and/or of a pipeline segment 114, where A1 denotes a type of pipe with horizontal extent and A2 denotes a type of pipe with vertical extent, i.e., an extent perpendicular to the horizontal extent.
Category B specifies a ratio of lengths in the entrance (L1) and/or exit (L2) and/or diameters in the entrance (d1) and/or exit (d2) and/or transition (d3), wherein six different combination options are listed in the kit 138.
Category C specifies ratios of lengths in the entrance (L1) and/or exit (L2) and lengths of passes. Here, all commutations denoted by Ci in the present case are conceivable.
Category D specifies whether the at least one pipeline 112 and/or the at least one pipeline segment 114 is configured with or without galvanic isolation and/or ground connection 125. The galvanic isolation may for example be configured using an insulator 124. D1 specifies a type of pipe in which a galvanic isolation is provided at the inlet 120 of the pipeline 112 and/or of the pipe segment 114 and a galvanic isolation is provided at the outlet 122 of the pipeline 112 and/or of the pipe segment 114. D2 specifies a type of pipe in which a galvanic isolation is provided at the inlet 120 of the pipeline 112 and/or of the pipe segment 114 and a ground connection 125 is provided at the outlet 122 of the pipeline 112 and/or of the pipe segment 114. D3 specifies a type of pipe in which a galvanic isolation is provided only at the inlet 120 of the pipeline 112 and/or of the pipe segment 114. D4 specifies a type of pipe in which a ground connection 125 is provided only at the inlet 120 of the pipeline 112 and/or of the pipe segment 114. D5 specifies a type of pipe in which the pipeline 112 and/or the pipe segment 114 is provided without a ground connection 125 at the inlet 120 and outlet 122 and/or without galvanic isolation at the inlet 120 and outlet 122.
Category E specifies a flow direction of the fluid. The fluid may basically flow in two flow directions. A type of pipe in which the fluid flows in a first direction is referred to as type of pipe E1, and a type of pipe in which the fluid flows in a second flow direction is referred to as type of pipe E2. The first and the second flow direction may be opposite.
Category F specifies an application of direct current to the pipeline 112 and/or to the pipe segment 114. F1 specifies a type of pipe in which an infeed of direct current is performed at an arbitrary location of the pipeline 112 and/or of the pipe segment 114 between at least two negative terminals and/or conductors. For example, the infeed may be performed in the middle between two negative terminals, such that a resistance of the pipeline 112 and/or of the pipe segment 114 is divided into two partial resistances R1 and R2. Half of the direct current can flow to a first negative terminal, and a second half can flow to a second negative terminal. The infeed may also be performed at an arbitrary location between the negative terminals/conductors, such that different partial resistances are realized. F2 specifies a type of pipe in which an infeed, or the connection, of the direct current is performed via a negative terminal and/or conductor and a positive terminal and/or conductor on the pipeline 112 and/or the pipe segment 114. For example, the direct current can flow from the positive to the negative terminal, and the pipeline 112 and/or the pipe segment 114 can be considered as an overall resistance R. Any desired combination of the types of pipe is possible here.

FIG. 9Ai shows a pipeline 112 and/or pipeline segment 114 of type of pipe A1D1F2. The pipeline 112 and/or the pipeline segment 114 has a horizontal extent. In this embodiment, the device 110 comprises two insulators 124, which are arranged after the inlet 120 and in front of the outlet 122. In respect of the further elements of FIG. 9Ai, reference can be made to the description of FIG. 5b. In FIG. 9Ai, possible flow directions Ei are illustrated by way of example by means of a double arrow at inlet 120 and outlet 122. In the further FIG. 9, the inlet 120 and outlet 122 are considered jointly. The example in FIG. 9Aii shows a type of pipe A1D2F2 and differs from FIG. 9Ai in that the device 110 only comprises an insulator 124, with a ground connection 125 being provided instead of the second insulator. The example in FIG. 9Aiii shows a type of pipe A1D3F2 and differs from FIG. 9Aii in that no ground connection 125 is provided. In FIG. 9Aiv, type of pipe A1 D4F2, the device 110 comprises, by contrast to FIG. 9Aiii only a ground connection 125 instead of the insulator. Embodiments without insulators 124 or ground connections 125 are also possible, as illustrated in FIG. 9Av, type of pipe A1 D5F2. FIGS. 9Ai to 9Avi show types of pipe in which an infeed of the direct current is performed via a negative terminal and/or conductor and a positive terminal and/or conductor on the pipeline 112 and/or the pipe segment 114. FIG. 9Avi shows a type of pipe A1F1 in which an infeed of the direct current is performed at an arbitrary location of the pipeline 112 and/or of the pipe segment 114 between at least two negative terminals and/or conductors.

FIG. 9Bi, type of pipe BiD1F2, illustrates lengths in the entrance (L1), exit (L2) and transition (L3) and diameters in the entrance (d1), exit (d2) and transition (d3). The device 110 may comprise pipelines 112 and/or pipeline segments 114 with different lengths in the entrance (L1) and/or exit (L2) and/or transition (L3) and/or diameters in the entrance (d1) and/or exit (d2) and/or transition (d3). In respect of the further elements of FIG. 9Bi, reference can be made to the description of FIG. 5b. The example in FIG. 9Bii shows a type of pipe BiD2F2 and differs from FIG. 9Bi in that the device 110 comprises only one insulator 124, wherein a ground connection 125 is provided instead of the second insulator. The example in FIG. 9Biii shows a type of pipe BiD3F2 and differs from FIG. 9Bii in that no ground connection 125 is provided. In FIG. 9Biv, type of pipe BiD4F2, the device 110 comprises, by contrast to FIG. 9Biii, only a ground connection 125 instead of the insulator. Embodiments without insulators 124 or ground connections 125 are also possible, as illustrated in FIG. 9Bv, type of pipe BiD5F2. FIGS. 9Bi to 9Bvi show types of pipe in which an infeed of the direct current is performed via a negative terminal and/or conductor and a positive terminal and/or conductor on the pipeline 112 and/or the pipe segment 114. FIG. 9Bvi shows a type of pipe BiF1 in which an infeed of the direct current is performed at an arbitrary location of the pipeline 112 and/or of the pipe segment 114 between at least two negative terminals and/or conductors.

FIG. 9Ci, type of pipe CiD1F2, shows an example in which the device 110 comprises pipelines 112 and/or pipeline segments 114 with a plurality n of passes, for example three, as illustrated here. The passes may each have different lengths L3, L4, L5 and/or diameters d3, d4, d5. In respect of the further elements of FIG. 9Ci, reference can be made to the description of FIG. 6. The example in FIG. 9Cii shows a type of pipe CiD2F2 and differs from FIG. 9Ci in that the device 112 comprises only one insulator 124, wherein a ground connection 125 is provided instead of the second insulator. The example in FIG. 9Ciii shows a type of pipe CiD3F2 and differs from FIG. 9Cii in that no ground connection 125 is provided. In FIG. 9Civ, type of pipe CiD4F2, the device 110 comprises, by contrast to FIG. 9Ciii, only a ground connection 125 instead of the insulator. Embodiments without insulators 124 or ground connections 125 are also possible, as illustrated in FIG. 9Cv, type of pipe CiD5F2. FIGS. 9Ci to 9Cvi show types of pipe in which an infeed of the direct current is performed via a negative terminal and/or conductor and a positive terminal and/or conductor on the pipeline 112 and/or the pipe segment 114. FIG. 9Cvi shows a type of pipe CiF1 in which an infeed of the direct current is performed at an arbitrary location of the pipeline 112 and/or of the pipe segment 114 between at least two negative terminals and/or conductors.

The device 110 may comprise a combination of at least two different types of pipe, which are connected in parallel and/or in series. By way of example, the device 110 may comprise pipelines 112 and/or pipeline segments 114 with different lengths in the entrance (L1) and/or exit (L2) and/or transition (L3). By way of example, the device may comprise pipelines and/or pipeline segments with an asymmetry of the diameters in the entrance (d1) and/or exit (d2) and/or transition (d3). By way of example, the device 110 may comprise pipelines 112 and/or pipeline segments 114 with a different number of passes. By way of example, the device 110 may comprise pipelines 112 and/or pipeline segments 114 with passes with different lengths per pass and/or different diameters per pass.

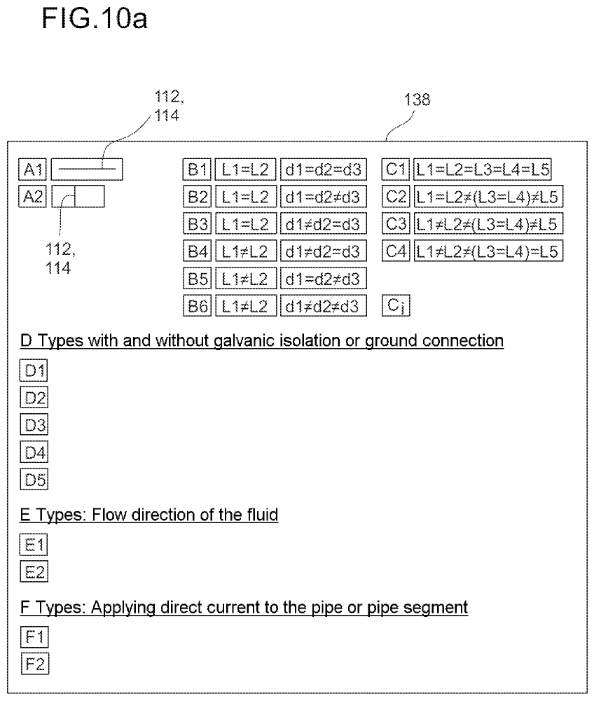

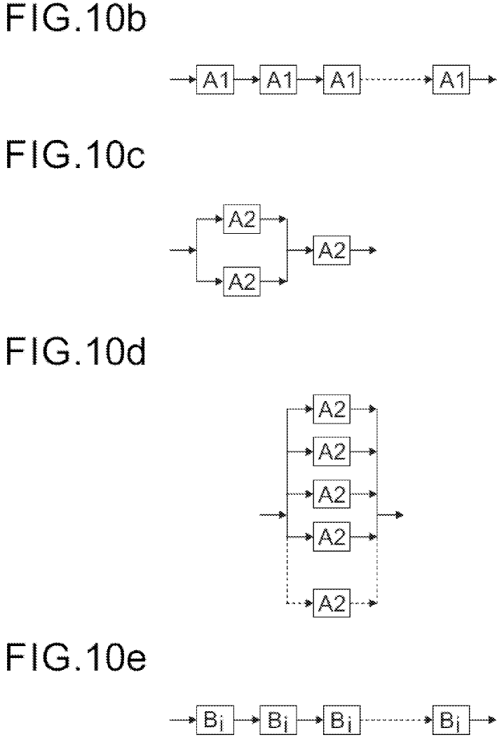

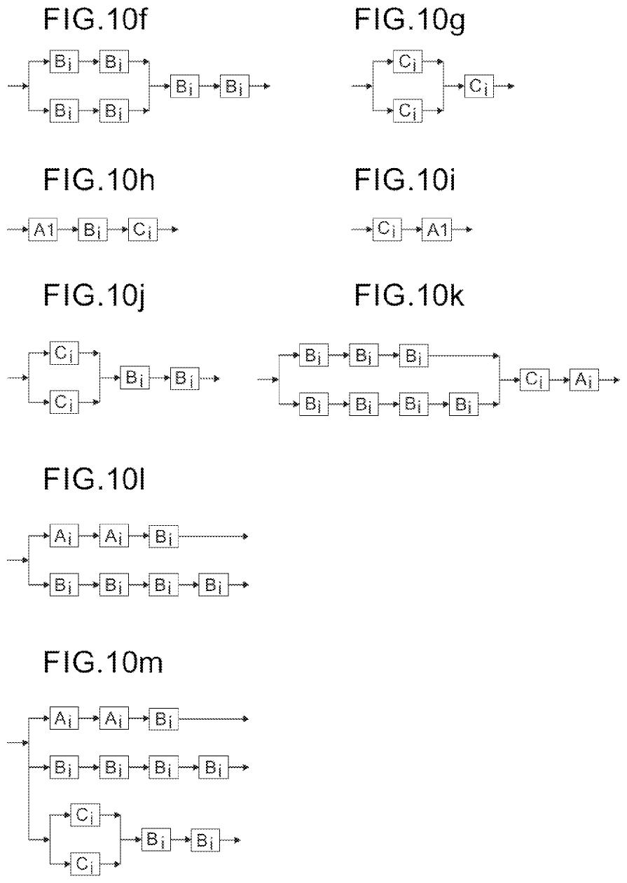

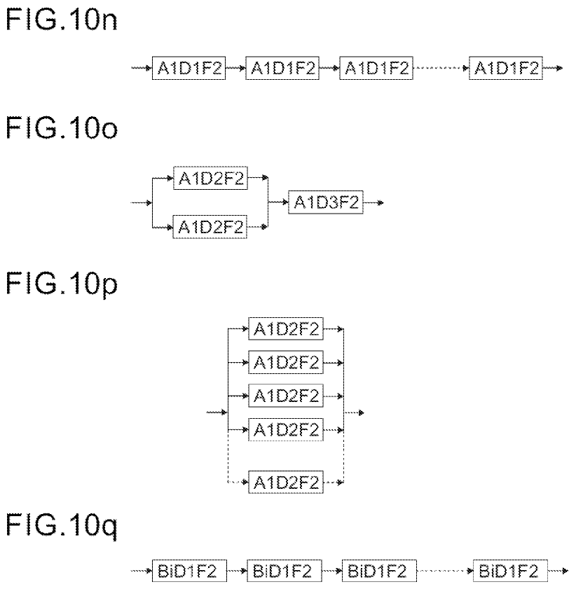

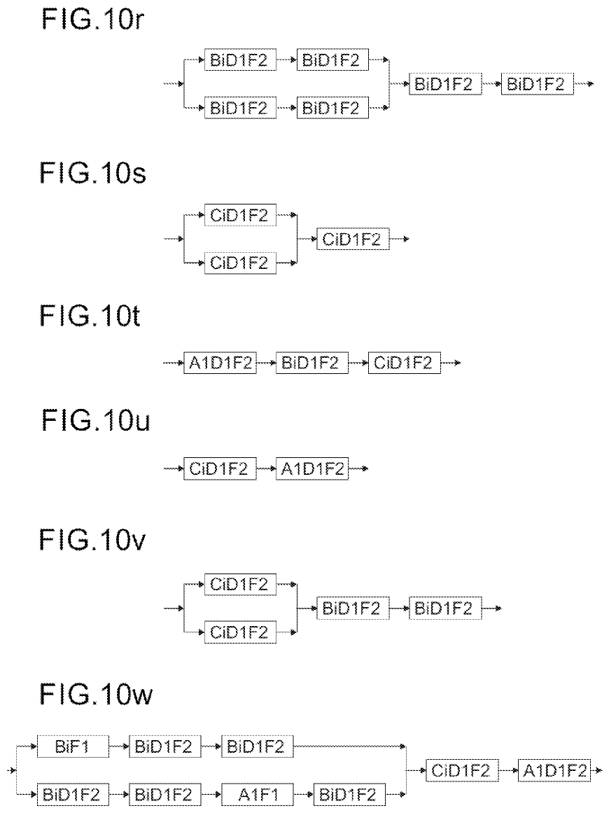

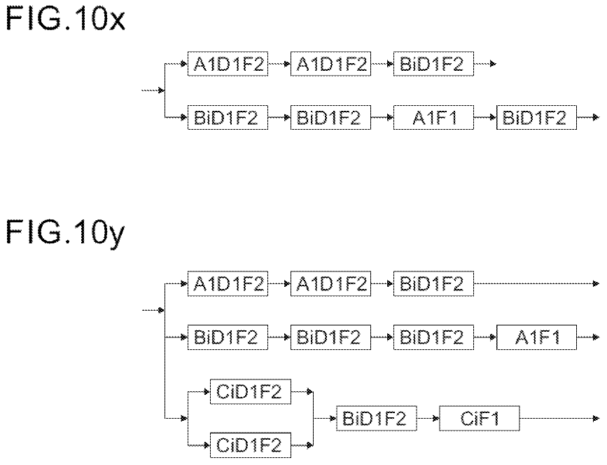

In principle, any combination of any type of pipe in parallel and/or in series is conceivable. Pipelines 112 and/or pipeline segments 114 may be available as different types of pipe in the form of a kit 138 and may be selected and combined as desired, depending on a use purpose. FIG. 10A shows an embodiment of a kit 138 with different types of pipe. FIGS. 10b to y show examples according to the invention of combinations of pipelines 112 and/or pipeline segments 114 of the same type of pipe and/or different types of pipe. FIG. 10b shows an example with three horizontal pipelines 112 and/or pipeline segments 114 of the A1 type of pipe, which are arranged in succession. FIG. 10c shows two vertical pipes of the A2 type of pipe connected in parallel and a subsequent pipeline 112 and/or a subsequent pipeline segment 114, likewise of the A2 type of pipe. FIG. 10d shows a plurality of pipelines 112 and/or pipeline segments 114 of the A2 type of pipe, all of which are connected in parallel. FIG. 10e shows an embodiment in which a plurality of types of pipe of the category B are arranged in succession. Here, the pipelines 112 and/or pipeline segments 114 can be identical or different types of pipe of the category B, which is denoted by Bi. FIG. 10f shows an embodiment with six pipelines 112 and/or pipeline segments 114 of category B, wherein two pipelines 112 and/or pipeline segments 114 are each arranged in two parallel strands and two further pipelines 112 and/or pipeline segments 114 are connected downstream thereof. FIG. 10g shows an embodiment with pipelines 112 and/or pipeline segments 114 of category C, wherein two pipelines 112 and/or pipeline segments 114 are connected in parallel and a pipeline 112 and/or pipeline segment 114 is connected downstream thereof. Mixed forms of categories A, B and C are also possible, as shown in FIGS. 10h to m. The device 110 may comprise a plurality of feed inlets and/or feed outlets and/or production flows. The pipelines 112 and/or pipeline segments 114 of different or identical type of pipe may be arranged in parallel and/or in series with a plurality of feed inlets and/or feed outlets, as illustrated in FIGS. 10k and 10m, for example.

FIGS. 10n to 10p show exemplary combinations of pipelines 112 and/or pipeline segments 114 of the categories A, D and F. FIGS. 10q and 10r show exemplary combinations of pipelines 112 and/or pipeline segments 114 of the categories B, D and F. FIG. 10s shows an exemplary combination of pipelines 112 and/or pipeline segments 114 of the categories C, D and F. FIG. 10t shows an exemplary combination of pipelines 112 and/or pipeline segments 114 of the categories A, D and F. FIG. 10u shows an exemplary combination of pipelines 112 and/or pipeline segments 114 of the categories A, C, D and F. FIG. 10v shows an exemplary combination of pipelines 112 and/or pipeline segments 114 of the categories B, C, D and F. FIGS. 10w and 10 y show exemplary combinations of pipelines 112 and/or pipeline segments 114 of the categories A, B, C, D and F. FIG. 10x shows an exemplary combination of pipelines 112 and/or pipeline segments 114 of the categories A, B, D and F. The device 110 may comprise a plurality of feed inlets and/or feed outlets and/or production flows. The pipelines 112 and/or pipeline segments 114 of different or identical type of pipe of the categories A, B, C, D, E and F may be arranged in parallel and/or in series with a plurality of feed inlets and/or feed outlets. Examples of a multiplicity of feed inlets and/or feed outlets and/or production flows are illustrated in FIGS. 100, 10p, 10r, 10s, 10v to 10y.

Using pipelines 112 and/or pipeline segments 114 of different types of pipe, it is possible to facilitate more accurate temperature control and/or an adaptation of the reaction in the case of varying feed and/or a selective yield of the reaction and/or an optimized process technology.

### LIST OF REFERENCE SIGNS

110 Device
111 Reaction space
112 Pipeline
114 Pipeline segment
116 Limb
118 Pipe system
120 Inlet
122 Outlet
124 Insulator
125 Ground connection
126 DC current and/or DC voltage source
128 Positive terminal/conductor
130 Negative terminal/conductor
132 Heating wire
134 First pipeline
136 Second pipeline
138 Kit

1. A device for heating a fluid, comprising
at least one electrically conductive pipeline and/or at least one electrically conductive pipeline segment for receiving the fluid, and
at least one DC current and/or DC voltage source, wherein respectively one DC current or DC voltage source is assigned to each pipeline and/or each pipeline segment, said DC current or DC voltage source being connected to the respective pipeline and/or the respective pipeline segment, wherein the respective DC current and/or DC voltage source is configured to produce an electric current in the respective pipeline and/or in the respective pipeline segment, said electric current warming up the respective pipeline and/or the respective pipeline segment by Joule heating, which arises when the electric current passes through conductive pipe material, for the purposes of heating the fluid, wherein the device comprises a plurality of pipelines and/or pipeline segments, wherein the pipelines and/or pipeline segments are through-connected and consequently form a pipe system for receiving the fluid, wherein the pipelines and/or pipeline segments and appropriate supply and removal pipelines are connected to one another in fluid conducting fashion, wherein the pipelines and/or pipeline segments and the supply and removal pipelines are galvanically isolated from one another.

2. The device according to claim 1, wherein the device comprises L pipeline segments, where L is a natural number greater than or equal to two, wherein the pipeline segments comprise asymmetric pipes and/or a combination thereof.

3. The device according to claim 1, wherein the device comprises insulators that are configured for galvanic isolation between the respective pipelines and/or pipeline segments and the supply and removal pipelines, wherein the insulators are configured to ensure a free through-flow of the fluid.

4. The device according to claim 1, wherein a plurality or all of the pipelines and/or pipeline segments are configured in series and/or in parallel.

5. The device according to claim 1, wherein the device comprises a plurality of DC current and/or DC voltage sources, wherein the DC current and/or DC voltage sources are configured with or without an option for closed-loop control of at least one electrical output variable.

6. The device according to claim 5, wherein the device for connecting the DC current or DC voltage sources and the respective pipeline and/or to the respective pipeline segment comprises 2 to N positive terminals and/or conductors and 2 to N negative terminals and/or conductors, where N is a natural number greater than or equal to three.

7. The device according to claim 5, wherein the respective DC current or DC voltage sources are configured differently.

8. The device according to claim 7, wherein the device comprises 2 to M different DC current and/or DC voltage sources, where M is a natural number greater than or equal to three, wherein the DC current and/or DC voltage sources are electrically controllable independently of one another.

9. An installation comprising at least one device according to claim 1.

10. The installation according to claim 9, wherein the installation is selected from the group consisting of: a steam cracker, a steam reformer, an apparatus for alkane dehydrogenation.

11. A method for heating a fluid by using a device according to claim 1, the method comprising the following steps:
providing at least one electrically conductive pipeline and/or at least one electrically conductive pipeline segment for receiving the fluid, wherein the pipelines and/or pipeline segments and appropriate supply and removal pipelines are connected to one another in fluid conducting fashion, wherein the pipelines and/or pipeline segments and the supply and removal pipelines are galvanically isolated from one another;
receiving the fluid in the pipeline and/or the pipeline segment;
providing at least one DC current and/or DC voltage source, wherein respectively one DC current or DC voltage source is assigned to each pipeline and/or each pipeline segment, said DC current or DC voltage source being connected to the respective pipeline and/or to the respective pipeline segment,
producing an electric current in the respective pipeline and/or the respective pipeline segment by the respective DC current and/or DC voltage source, said electric current warming up the respective pipeline and/or respective pipeline segment by Joule heating, which arises when the electric current passes through the conductive pipe material, for the purposes of heating the fluid.

12. The method according to claim 11, wherein the fluid comprises a hydrocarbon to be thermally cracked.

13. The method according to claim 11, wherein the fluid comprises water or steam, wherein said water or said steam is heated to a temperature in the range of 550° C. to 700° C., and the fluid additionally comprises a hydrocarbon to be thermally cracked.

14. The method according to claim 11, wherein the fluid comprises combustion air of a reformer furnace to a temperature in the range of 200° C. to 800° C.

15. The device according to claim 5, wherein the respective DC current or DC voltage sources are configured identically.

16. The method according to claim 12, wherein the fluid is a mixture of hydrocarbons to be thermally cracked.

17. The method according to claim 13, wherein the fluid comprises a mixture of hydrocarbons to be thermally cracked.

18. The method according to claim 13, wherein the fluid is a preheated mixture of preheated hydrocarbons to be thermally cracked and steam.

19. The method according to claim 14, wherein the fluid is heated to a temperature in the range of 400° C. to 700° C.
